(19) United States
(12) Patent Application Publication
(10) Pub. No.: US 2025/0307938 A1
(43) Pub. Date: Oct. 2, 2025

(54) COMPUTERIZED METHOD AND SYSTEM CALCULATING RISKS ASSOCIATED WITH FIDUCIARY REQUIREMENTS

(71) Applicant: Fiduciary In A Box, Inc., Red Bank, NJ (US)

(72) Inventors: Jed Cohen, West Orange, NJ (US); Jamie Greenleaf, Rumson, NJ (US); Patrick Williams, Palm Beach Gardens, FL (US)

(21) Appl. No.: 19/097,701

(22) Filed: Apr. 1, 2025

Related U.S. Application Data
(60) Provisional application No. 63/572,395, filed on Apr. 1, 2024.

(51) Int. Cl. G06Q 40/06; G06Q 10/0635; G06Q 10/1057; G06V 30/10

(52) U.S. Cl. CPC G06Q 40/06; G06Q 10/0635; G06Q 10/1057; G06V 30/10

(57) ABSTRACT

A computerized method provides for generating a risk assessment associated with fiduciary compliance requirements. The method includes generating a user interface screen and generating an output display to the user, including questions to user associated with the employee benefit program. The method includes receiving user input via the user interface screen. The method includes electronically processing both the user input in response to the at least one of the questions and the review of the benefits data, including comparing the user input and the benefit data to a plurality of fiduciary rules and generating a risk assessment score the electronic processing, indicating a compliance of fiduciary requirements and generating an electronic output of instructions for the user to modify the risk assessment score.

### RELATED APPLICATIONS

The present invention relates to and claims priority to U.S. Provisional Application 63/572,395 entitled “Data Processing System for Data Management” filed Apr. 1, 2024, the entirety of which is hereby incorporated by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to a data processing system and more specifically to data processing and executable routines providing for financial data management.

### BACKGROUND

There are numerous legal and regulatory requirements for managing employer sponsored benefit plans. For example, the many requirements are spelled out as part of the Employee Retirement Income Security Act (ERISA).

ERISA establishes a fiduciary standard for employer sponsored benefits plans. Retirement and Health & Welfare benefit plans are both covered under these requirements, but implementing a fiduciary governance process, and documenting adherence to that process requires expertise, continuous diligence to maintain up to date records, and knowledge of new legislation, regulation, and best practices.

Previously, employers would defer managing benefit plans to skilled specialists, such as a financial managers and related companies. These sources manually control plans by institutional knowledge of retirement planning, often using standardized forms and institutional knowledge for satisfying the various management guidelines or requirements.

This process is not only extremely cost ineffective, but is limited to the skills and knowledge of the manager(s) and individuals offering the plan management services. Moreover, employers offering such plans and not having a robust fiduciary process opens them up to significant liabilities.

The complication of rules and data associated with effectively running and managing a benefits plan are data points that can define baseline data processing requirements, but there are no existing solutions for translating and executing employee benefit plan management within an executable environment. Current solutions rely almost exclusively on personal knowledge and do not account for data processing operations and executable routines for disparate data sets to offer data management solutions, including processing solutions associated with financial plan data management.

As such, there exists a need for a computerized method and processing system for generating a risk assessment associated with fiduciary compliance and user interface functions for reducing attendant risk for a user operating an employee benefits program.

### SUMMARY OF THE INVENTION

A computerized method and system provides for generating a risk assessment associated with fiduciary compliance requirements for a user, where the user represents a business entity having a plurality of employees and operating an employee benefit program for the plurality of employees. The method and system includes generating a user interface screen based on execution of executable software code by at least one processing device, the first user interface screen viewable by the user and transmitting the executable software code to a user processing device and generating an output display to the user, including displaying a plurality of questions associated with the employee benefit program to the user.

The method and system applies to retirement benefit plans, health benefit plans, and any other suitable plan having fiduciary requirements.

The method and system further includes receiving user input via the user interface screen, the user input including both user input in response to at least one of the questions and access to information having benefits data stored therein, the benefits data associated with the employee benefit program and electronically accessing, via a networked connection, the information having the benefits data stored therein and reviewing at least a portion of the benefits data stored therein.

The method and system further includes electronically processing both the user input in response to the at least one of the questions and the electronic review of the at least a portion of the benefits data, wherein the processing includes comparing the user input and the benefit data to a plurality of fiduciary rules. The method and system further includes generating a risk assessment score the electronic processing, where the risk assessment score indicates a compliance of fiduciary requirements associated with the employee benefit program and based on the risk assessment and the electronic processing, generating an electronic output of instructions for the user to modify the risk assessment score.

In a further embodiment, the user is prompted via the user interface to upload a plurality of documents relating to the employee benefits program and software instructions providing electronically storing an electronic version of the plurality of documents in a document repository such that electronically accessing the access information includes accessing the document repository. In one embodiment, the method and system includes executing content recognition executable software and reviewing the electronic version of the plurality of documents using the content recognition executable software including reviewing the written content within the plurality of documents.

In a further embodiment, the electronic version of the plurality of documents includes at least one contract associated with the employee benefit program.

In a further embodiment, the computerized method and system further includes generating at least one task for the user based on the review of the electronic version of the plurality of documents.

In a further embodiment, the computerized method and system further includes, upon reviewing the electronic version of the plurality of documents, electronically generating document tags based thereon and assigning the document tags within the document repository. Another embodiment includes analyzing the document tags and generating a plurality of time-based reminders for the user based thereon.

In a further embodiment, the computerized method and system further includes, for at least one of the electronic versions of the plurality of documents, comparing the electronic version to a document template and generating a notification to the user based on the comparison, wherein the notification includes at least one statement of variance between the electronic version and the document template.

In a further embodiment, the computerized method and system further includes, as part of the user interface and the display of the plurality of questions, generating an input option for the user to seek computerized assistance with at least one of the plurality of questions and in response to receipt of a computerized assistance request, generating a computerized response for the user including recommendations associated with modifying the risk assessment score.

In one embodiment, the benefits data is accessed via a third-party database having the information stored therein, the user interface further includes generating at least one inquiry to the user requesting account information associated with the third-party database and accessing the third-party database using the account information via the networked connection. The third-party database may be associated with a third-party service provider associated with providing the employee benefit program, the third-party service provider including at least one of: a benefit plan administrator, a fiduciary training provider, a document repository.

In a further embodiment, the computerized method and system further includes accessing a best practices database having a plurality of data points relating to best practices associated with management of the employee benefits program and selecting at least one of the instructions for the user to modify the risk assessment score based on accessing the best practices database.

In a further embodiment, the computerized method and system further includes tracking user input in response to the questions and tracking analysis of the third-party database and generating a status indicator as part of the user interface, the status indicator relating to modifying the risk assessment score. This embodiment may further include transmitting at least one inquiry to a third-party service provider in addition to processing the user input, the at least one inquiry including inquiries regarding the employee benefits program as supported by the third-party service provider, receiving a third-party input in response to the at least one inquiry, and modifying the risk assessment score based on the third-party input.

Generally, the method and system includes a computer-implemented system that guides employers through fiduciary compliance for ERISA-covered benefit plans. The method involves interactive software prompting users to upload documents, answer questions, and complete tasks tied to regulatory best practices.

The method and system includes dynamic task and compliance scoring, as well as user input and document uploads to track completion of compliance tasks. It assigns a “score” that reflects fiduciary risk, dynamically updating as more tasks are completed.

The method includes document analysis and comparison. Uploaded documents are scanned (e.g., via OCR) to detect non-compliant language. The system compares documents against pre-approved templates or similar files uploaded by other users, flagging deviations or improvements.

The method includes data tagging and reminders. Documents are automatically tagged with metadata (plan year, vendor name, etc.). These tags drive automated reminders (e.g., annual document refresh deadlines). Documents are also automatically titled and sorted for easy access, and secure sharing.

The method includes user interaction logic. The system adjusts tasks and recommendations in real time based on previous answers and detected compliance gaps. One embodiment includes using a decision tree or weighted algorithm to assess the relative importance of each compliance item.

The method includes third-party integration. The system integrates with third-party education or training providers to track training completions or compliance-related milestones. Integrations will also include data analytics providers, AI platforms, etc., allowing the FIAB system to collect and sort completed reports/information from each integrated third party, and update our compliance system with the results. The system can ingest data from third-party systems-such as benefit plan administrators, fiduciary training providers, or document repositories—and automatically generate actionable next steps for users. These prompts help users increase fiduciary compliance and reduce risk, without needing to manually interpret third-party data.

The method further includes a multi-tenant enterprise system. A networked environment serving multiple users or organizations, using centralized or cloud-based processing and storage.

The method and system further includes an enterprise dashboard for multi-client oversight. The platform supports “enterprise users” (e.g., consultants, TPAs, broker-dealers) who manage benefit plans across multiple employer clients. These users can: access aggregated reporting across all clients; identify clients with incomplete fiduciary processes; highlight business development opportunities or compliance risks at scale; and/or filter, flag, or benchmark based on plan type, vendor relationships, or common deficiencies.

The method may further include contextual help, referencing a database of best practices to provide information and guidance surrounding the specific task/question/document. The ability to concurrently manage multiple plan years, documenting both the current plan year and previous years to ensure that documentation is in place to manage liability over time.

The system includes automatically analyzing documents from previous plan years and comparing them with documents for the current plan year to identify potential compliance requirements. For example, if last year's Summary Plan Document (SPD) differs significantly from this year's SPD, the plan may need to file a Summary of Material Modification (SMM).

The system includes functions for an Employer to send a request, via the FIAB system, to a 3rd party vendor requesting they enter answers/upload documentation directly to the system for the Employer's review and approval.

Another embodiment includes the ability to compare an “outside fiduciary audit report” to the underlying plan document to determine if the plan is being administered in accordance with the plan document.

### DESCRIPTION OF THE DRAWINGS

The invention will be described with respect to the following drawing figures, in which like numerals represent like features throughout the description, and in which:

FIG. 1 illustrates a computer operating system;

FIG. 2 illustrates another embodiment of a computer operating system;

FIG. 3 is a flowchart of the steps of one computerized method for generating a risk assessment;

FIG. 4 is a flowchart of one embodiment of account creation and management;

FIG. 5 is a flowchart of one embodiment of setting up a benefits plan;

FIG. 6 is a flowchart of one embodiment of documenting and managing information related to a fiduciary committee;

FIG. 7 is a flowchart of one embodiment of identifying and processing information regarding vendors associated with a plan;

FIG. 8 is flowchart of one embodiment of analyzing, documenting, educating and communicating with participants;

FIG. 9 is a flowchart of one embodiment of regulation compliance analysis; and

FIG. 10 is a flowchart of one embodiment of standards compliance and document management.

### DETAILED DESCRIPTION

The present invention is a data processing and data management system for processing data sets in response to executable instructions. The data processing includes information relating to employer sponsored benefit plans.

There are no existing solutions for electronically generating risk assessments associated with benefit programs. The technical problem is the large amount of data needed for benefits management, coupled with the administration and regulatory requirements for the benefits program, and compounded by the typical-user having a lack of familiarity with both the data and admin/regulatory requirements. As such, the present method and systems offers a technical solution of data transformation including content recognition and translation of data sets relative to regulatory requirements, and executable code for user interfacing functionality for both data request and user management actions. Based thereon, the method and system offers a technical solution of using the data translation and data analysis, relative to electronically-defined guidelines, for generating risk assessment and directing the user for benefit program management.

The present invention uses executable software instructions for performing processing routines on various data sets, including related and disparate data sets. The processing routines include accessing checklists and data tables for referencing incoming data. The processing routine includes data upload and content recognition processing routines, processing of the uploaded and recognized data relative to pre-existing data metrics, reference and/or look-up tables, and other data sets. The processing routine includes analysis of varying uploaded and reference data, including determination of verbiage, phasing, clauses, or other terms, and cross-references and/or cross-populating that analysis with related and/or disparate data sets.

The present method and system operates primarily with financial services related to employee benefit plans as administered by non-skilled fiduciaries. The executable software, data sets, and data management routines generate software as a service for fiduciary compliance requirements and determination of management and best-practice routines not available with the pre-existing manual techniques.

The present method and system operates using computer processing routines in response to executable instructions and based on incoming data and reference data sets. The executable routines can be performed on a local stand-alone processing device or system, or can be within a networked or enterprise environment.

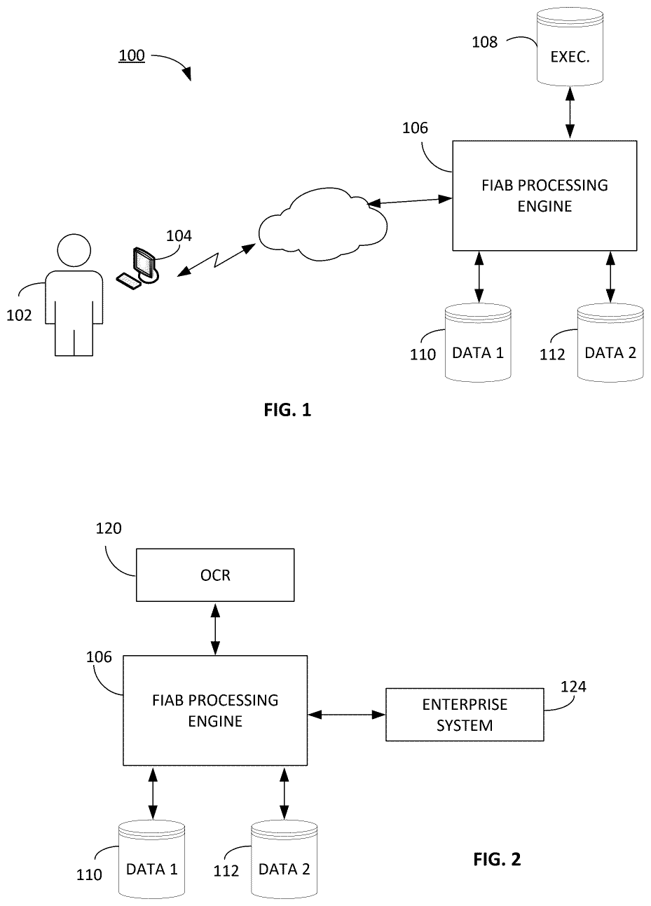

FIG. 1 illustrates one exemplary embodiment of an enterprise system 100 with a first user 102 running interface software on a first device 104. The device 104 engages in network communication with at least one server 106 across the network, such as the Internet. The server 106 may be one or more processing devices in a central or distributed platform, operative to perform processing operations noted herein. For example, one embodiment may include a cloud-based processing system accessible via a browser or other software executable running on the device 104.

In the network, there are multiple databases, exemplary illustrations of databases 108, 110, and 112. There can be any number of different databases or they can be merged or integrated into a single memory structure.

By way of example, database 108 may store executable instructions for the server 106, database 110 may store reference data, and database 112 may store specific data for user 102.

In one example, the user 102 can represent a business owner or benefits manager. In the enterprise software embodiment, a web portal, local executable, or other software implementation may be used to create the data communication pathway for interacting with the server 106.

In one example, the executables and data processing operations noted herein can be locally executed, for instance on device 104. With local execution, network communication to databases 110-112 can be included for improved data processing and content recognition operations.

The executables, performed locally or on a server in an enterprise format, provides a system that details best practices for establishing to and adhering to a fiduciary process for the management of an ERISA covered health and welfare benefits plan. The executables further provide for organization and storage of documentation demonstrating adherence to the fiduciary process, as well as identifying gaps within the process that could expose the plan sponsor to liability. Additionally, the executables further measure the completeness of the employer's fiduciary process.

Moreover, while FIG. 1 illustrates user 102, the present computing method and system can operate with any number of varying users and devices. For example, the server 106 can provide enterprise software services to hundreds or thousands of different account users via their individual processing software or portal applications. The illustration of a single user 102 is exemplary and not limiting in scope.

The computer processing methodology uses stepwise user interactions for informing the user of data requirements, receiving data from the user, referencing the user data versus reference data, and iteratively supplement both user input and output for managing the benefit plan(s) consistent with required guidelines.

As users progress through the computing platform, they are prompted to upload all pertinent documents governing the benefits plan. If the documentation requested is not available, a task or reminder is created to prompt the user to locate and upload documentation. The documentation is organized into an integrated secure file storage system that allows for management of access to appropriate files via permission settings.

As the system progresses through the system, uploading, generating, and/or modifying documentation, the system algorithmically produces a score for the company. As more tasks are completed and the completion is verified, the score increases. The increase in score indicates a reduction in fiduciary risk.

In one embodiment, as the document is uploaded, that document is scanned using Optical Character Recognition (OCR), or any other suitable method, to identify any potentially non-compliant words, phrases, etc. For example, one or more reference databases can include data of proper and may include typical improper terms, phrases, clauses, etc. When a document is determined to include questionable content, the document can be flagged for additionally review.

FIG. 2 illustrates another embodiment of the computer processing system, including engine 106 and data storage devices 110 and 112. This processing system further includes an optical character recognition (OCR) engine 120 for scanning and analysis of text-based documents. Documents can include any suitable document used for managing an employee benefits program, including but not limited to contracts with vendors, management documents, employee forms, among others.

The FIG. 2 system further illustrates an enterprise system 124. The enterprise system can be any suitable enterprise-wide system offering benefits or assisting in management of a benefits program. For example, one type of enterprise program may be a payroll management platform. For example, one type of enterprise program may be a benefits management platform.

FIG. 2 illustrates the engine 106 external to the enterprise system 124, but this is for illustration purposes only and not expressly limiting. For example, one embodiment may include the engine 106 embedded within the system 124. In another example, the engine 106 may be split with independent modules operating external to the system 124 and other modules disposed within the system 124.

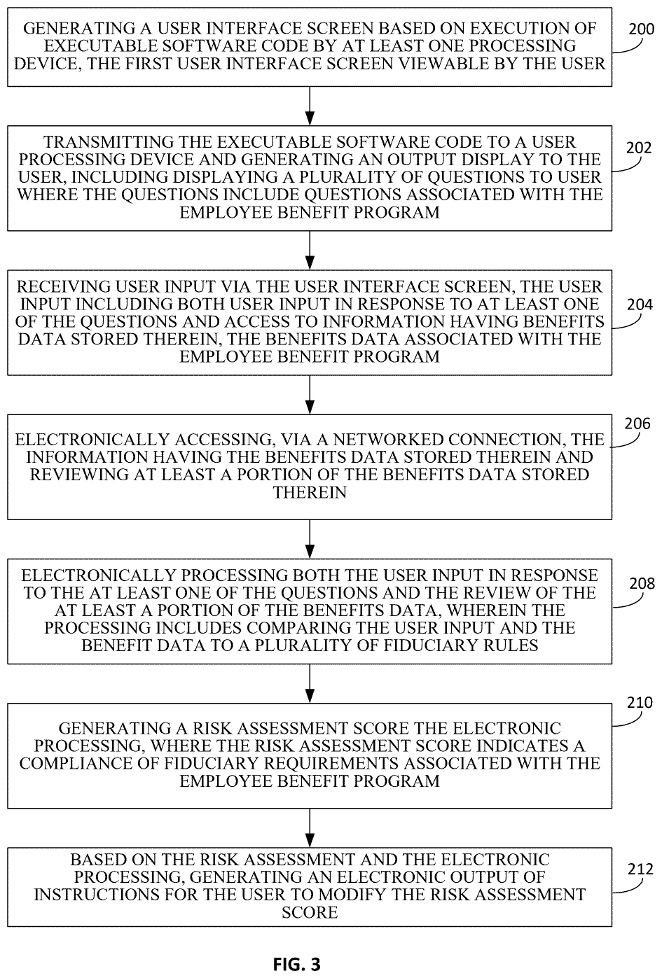

The flowcharts of FIGS. 3-10 can be performed using the systems of FIGS. 1 and/or 2. FIG. 3 is a computerized method for generating a risk assessment associated with fiduciary compliance requirements for a user, where the user represents a business entity having a plurality of employees and operating an employee benefit program for the plurality of employee.

Step 200 is generating a user interface screen based on execution of executable software code by at least one processing device, the first user interface screen viewable by the user. The user interface screen provides for user engagement, as well as additional functions as noted herein.

Step 202 is transmitting the executable software code to a user processing device and generating an output display to the user, including displaying a plurality of questions to user where the questions include questions associated with the employee benefit program. In one embodiment, the user interface can be via downloadable software. In another embodiment, the user interface can be accessible via a browser or other network-based connection.

Step 204 is receiving user input via the user interface screen, the user input including both user input in response to at least one of the questions and access to information having benefits data stored therein, the benefits data associated with the employee benefit program. The questions can relate to the development and/or management of the benefits program, including relating to compliance issues.

Step 206 is electronically accessing, via a networked connection, the information having the benefits data stored therein and reviewing at least a portion of the benefits data stored therein. This step can be performed via any number of processing routines. For example, one routine can include accessing a database having data stored therein. For example, one routine can include executing an OCR engine to capture text-based documents.

Step 208 is electronically processing both the user input in response to the at least one of the questions and the review of the at least a portion of the benefits data, wherein the processing includes comparing the user input and the benefit data to a plurality of fiduciary rules.

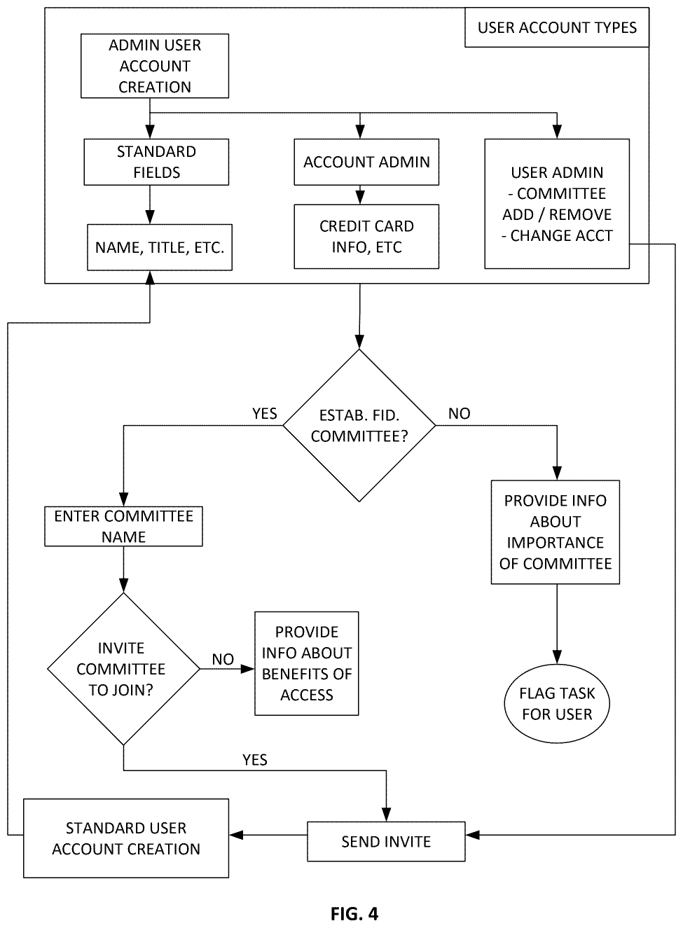

In one embodiment, referencing can include translating the user input and document review into a checklist. For example, iterative review can review the input and documents searching for specific data points tied to the plan. This can include a reference dataset of conformance factors and comparing the data points to these conformance factors. In a further embodiment, as noted in FIGS. 4-10 below, this can be performed step-wise with inquiries and analysis completed for each individual requirement or conformance factor.

Step 210 is generating a risk assessment score the electronic processing, where the risk assessment score indicates a compliance of fiduciary requirements associated with the employee benefit program. In the above example of referencing a data set, the risk assessment score can be a scaled value based on the number of completed conformance factors. In one embodiment, the scaling can be linear indicating completion of a percentage of tasks. In another embodiment, the scaling be weighted by giving completion factors different weights.

Step 212 is based on the risk assessment and the electronic processing, generating an electronic output of instructions for the user to modify the risk assessment score. The risk assessment score accounts for knowledge of missing factors, therefore part thereof is presenting the user with follow-up inquires for improving compliance and therefore reducing the risk assessment score. Inquiries can include any suitable format for example generating calendar invites, a task list, docking reminders, email notifications, among others.

FIGS. 4-10 illustrate varying embodiments of data processing and electronic interaction routines for data management, herein the data management relating to employee health benefit plans. The illustrated embodiments are exemplary in nature, representing data processing algorithms and data management, wherein variations in the execution of the methodology but generating the same results is within the scope herein.

FIG. 4 illustrates a data flow operation for account creation and management. In addition to standard account creation details, e.g. name, company, credit card, admin account(s), etc., the account creation includes a first question if the user has established a fiduciary committee. This inquiry illustrates one embodiment of flagging tasks for the user, where if a committee has not been formed the computing methodology then adds this task to a list of tasks for the user to complete for being in compliance.

The Admin User Account Creation process involves setting up an account for an administrative user. There are different types of admin users, including: Admin User (internal vs. external); Committee Member; Auditor.

The system also handles Account Administration, which includes: Adding Committee Members; Removing Committee Members; Changing the Admin Account. The system collects Standard User Fields during account creation, such as: First Name; Last Name; Company Name; Title; Email Address; Password; Credit Card Info/ACH Info; Subscription Details; Other suggested fields.

An inquiry asks have you established a fiduciary committee? If YES: Enter Committee Name. Would you like to invite the committee members to join? If YES: Send Invitation. If NO: Provide information about the benefits of providing access to the Platform. Register for a User (represented by a blue star, indicating the start of the Standard User Account Creation process).

If NO: Provide information about the importance of creating a committee. Register for a User (represented by a blue star, indicating the start of the Standard User Account Creation process).

The flowchart outlines the steps for creating and managing different types of user accounts, particularly focusing on the role of committees and inviting members to join the platform. It highlights the decision points related to committee involvement and emphasizes the importance of providing information to users about the platform's benefits and the significance of establishing committees.

The methodology includes further processing steps for committee members, such as invitations to join and centrally managing log-ins and other features associated with the members' accounts.

In one embodiment, as documents are uploaded, they can be tagged with various meta data or other tags. Examples can include a plan year, document type, vendor name, among others. For example, by having a tag of the plan year, a processing routine can automatically flag an annual reminder to update said document or information. The tagged information is usable for data management, data storage, docketing or timing reminders, among other functions.

In another example, if two users upload an Administrative Services Only (ASO) agreement with the same third-party administrator (TPA), the system can identify if one agreement contains non-compliant language while the other does not. This information can help the system advise User #1 to negotiate similar edits to their agreement.

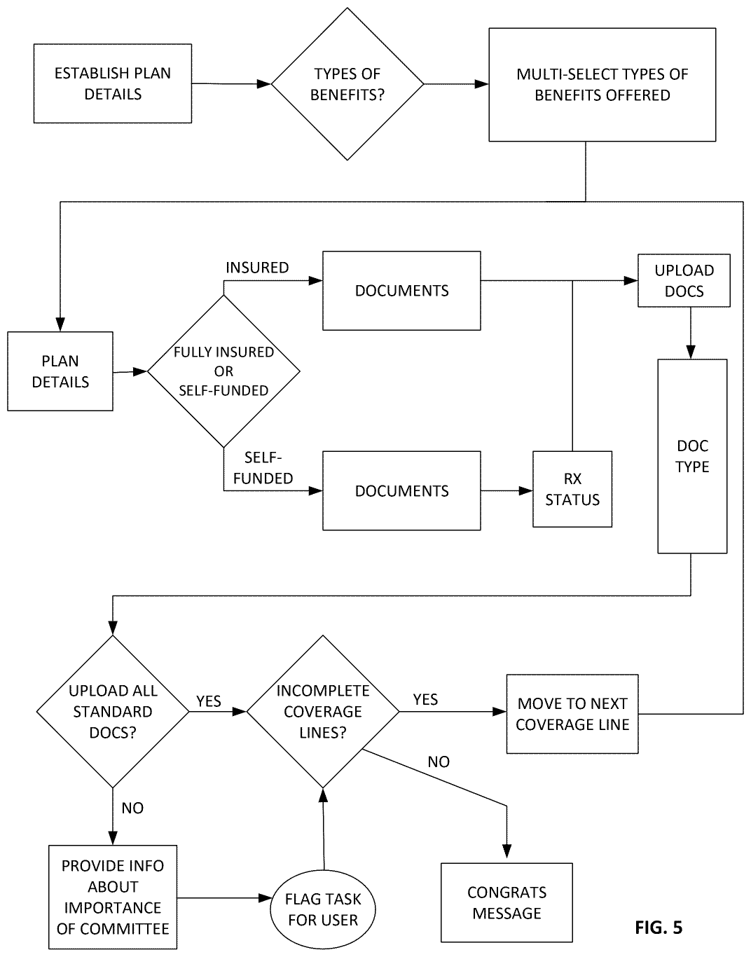

FIG. 5 is a sample data flow/algorithmic process for a plan set-up. These operations are executable via software processing steps using the system of FIG. 1, in one embodiment. These steps including which type of plan to set-up, questions regarding insured or self-funded, among others. This set-up flowchart includes another data tracking/data flagging operation, in this embodiment relating to uploading standard documents. If all standard documents are not uploaded, the task is flagged.

The process begins with Establishing Plan Details. The user provides basic information about the plan. An inquiry is What specific types of benefits will your welfare benefits plan offer?

The user can select from a list of various benefit types. This is a multi-select, meaning you can choose more than one. The options include, but are not limited to: Health; HSA (Health Savings Account); HRA (Health Reimbursement Arrangement); STD (Short-Term Disability); Hospitalization; Mental Health; Dental; FSA (Flexible Spending Account); Life; LTD (Long-Term Disability); Rx (Prescription Drugs); Vision; LP FSA (Limited Purpose Flexible Spending Account); Accident; Critical Illness; Legal; and/or Pet/Other.

Is this plan fully insured or self-funded? If Fully Insured: Fully Insured plans are described by the appropriate documents. If Self-Funded: Self Funded plan are described by specific documents. The user may provide documents, or in another embodiment provide access to one or more system having said documents.

Is your Rx plan carved out or bundled with your medical plan? This question specifically addresses the prescription drug (Rx) benefit. User indicates whether the Rx coverage is separate (carved out) or included within the medical plan (bundled).

The user can be prompted to upload the relevant plan documents.

Tag the document with a “Type”, such as: SBD (Summary Benefit Description); SPD (Summary Plan Description); 125; MSA (Medical Savings Account); and others.

Another inquiry is if there are more coverage lines? If YES: Move to next coverage line. If NO: Display message congratulating them for consolidating and organizing their plan documentation.

Another inquiry is if the user selected all the standard coverage types for the coverage line? If YES: Display message highlighting the types of benefits selected for the line and encouraging them to locate and upload the docs, or mark as N/A. If NO: Flag task for user. (This indicates a user needs to address a missing selection).

In essence, this flowchart guides a user through the process of setting up a benefits plan by: Selecting the types of benefits offered; Specifying whether the plan is fully insured or self-funded; Providing plan documents and categorizing them; Handling Rx coverage details; Iterating through multiple benefit types; and Ensuring all required selections are made and documents are uploaded.

Similarly, one embodiment can include scanning or other types of content recognition to determine if uploaded documents are proper in form and substance. For example, one technique may include optical character recognition and comparing the content to reference data. One type of comparison can be looking for standard or legally required language within the documentation.

In one embodiment, the compare/upload operations can include either or both detecting acceptable terminology and detecting unacceptable terms. Content recognition and comparison to baseline or reference data can further include updating or modifying terms or conditions based similar documents having acceptable language. Moreover, comparison for terms and related conditions or elements associated with the document can be beyond the document itself, but can also include meta data or other reference data associated therewith, including for instance the user or company providing the document.

By way of example, a first document can be uploaded with content recognition. The first document is uploaded by a first employer working with a third party administrator (TPA). This document may, in this example, be an Administrative Services Only (ASO) agreement. A second employer engages the platform, where there are similarities between the first employer and the second employer, e.g. if the second employer is also working with the same TPA. In this case, the method and processing system can anticipate both the first employer and the second employer will have identical or nearly identical ASO agreements with the common TPA.

The method and system recognize and track content between these related documents. For example, if prohibited or objectionable language is identified in the ASO agreement for the first employer, the processing method and system could anticipate said prohibited or objectionable language in the second employer ASO agreement. The method and processing system can therefore dynamically manage related documents. For example, upon finding objectionable language in the first ASO agreement, the method and system analyzes the second ASO agreement to determine the language has been removed or corrected. Therein, the method and processing system can notify the first employer about the cured ASO agreement terminology found within the system as well as providing a recommendation of corrective language consistent with the approved second ASO agreement.

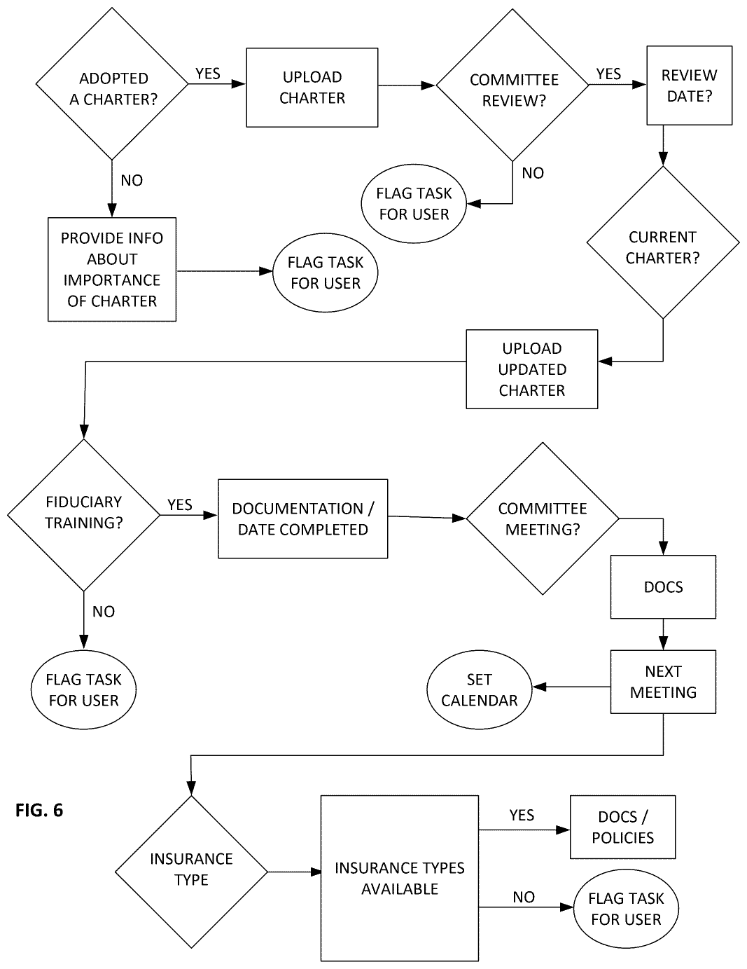

FIG. 6 is a sample data flow operation for documentation relating to a fiduciary committee. This flow diagram includes additional task flagging operations, including tasks and concerns relating to creating and/or reviewing a charter, as well as fiduciary training options. As the user or users process through the user interface, the incoming data is tracked, managed, and referenced where appropriate. The tracking of data includes flagging operations, which relate directly to the strength or appropriateness of the plan management.

Herein, flagging of tasks for users can include not only determining a task has not been completed, but also determining that a task has been performed but that performance is below a threshold level. In one example, OCR software can scan documentation such as a charter, determining that the charter itself exists. But a data comparison of the recognized charter content relative to the reference database can establish a weighted value or scaling value of the charter, for example determining that it is insufficient on one or more terms, conditions, statements, etc. Thus, one embodiment can include flagging the task for creating a document where one does not exist but also flagging a task to revise or improving the document should it be insufficient.

The computing method and system includes a reference of best practices, largely generated from years of experience executing fiduciary processes for retirement plans, and applying that experience to the health benefits space. Those best practices are represented in the questions posed to users. Any question that is skipped, or document that is not uploaded, is a “gap” in the user's fiduciary process. Those gaps are summarized, and listed for the user's review, and reminders are set to encourage the user to complete those tasks at a later date. Often these are recurring tasks (like uploading minutes from the most recent committee meeting, or uploading updated documents for the new plan year).

When each of these tasks is completed, a gap is closed, and the fiduciary process becomes more comprehensive and thorough. By using best practices, identifying gaps, and providing reminders, our system ensures that the user's fiduciary process is complete and compliant.

The flowchart starts with several independent questions that can be addressed in any order. “Has your committee adopted a charter?” If YES: Upload Documentation (Charter). The user committed to a charter. Enter date reviewed. When was your most recent updated Charter last reviewed? Documentation (updated charter).

If NO: Provide information about the importance of adopting a charter. Flag task for user.

Another inquiry is “Has everyone on the committee completed fiduciary training?” If YES: Documentation data completed. If NO: Flag task for user.

Another inquiry is “When was your first fiduciary meeting?” Documentation (minutes). When is the next meeting scheduled? Set a reminder to upload meeting minutes.

Another inquiry is “What type of insurance do you have in place to protect your committee members?” If YES: user is presented with several options: Fiduciary Insurance; Co-Fiduciary Experts; Directors & Officers; Other; Errors & Omissions; and/or Documentation (policies). If NO: Flag task for user.

This flowchart guides the user through documenting and managing key aspects of a Fiduciary Committee, including: Charter adoption and review: Ensuring the committee has a formal charter and that it's regularly updated; Fiduciary training: Tracking whether all members have received necessary training; Meeting records: Documenting meeting dates and minutes; and Liability insurance: Identifying and documenting the types of insurance in place to protect committee members.

The process is designed to ensure compliance and proper record-keeping for the committee's activities and responsibilities.

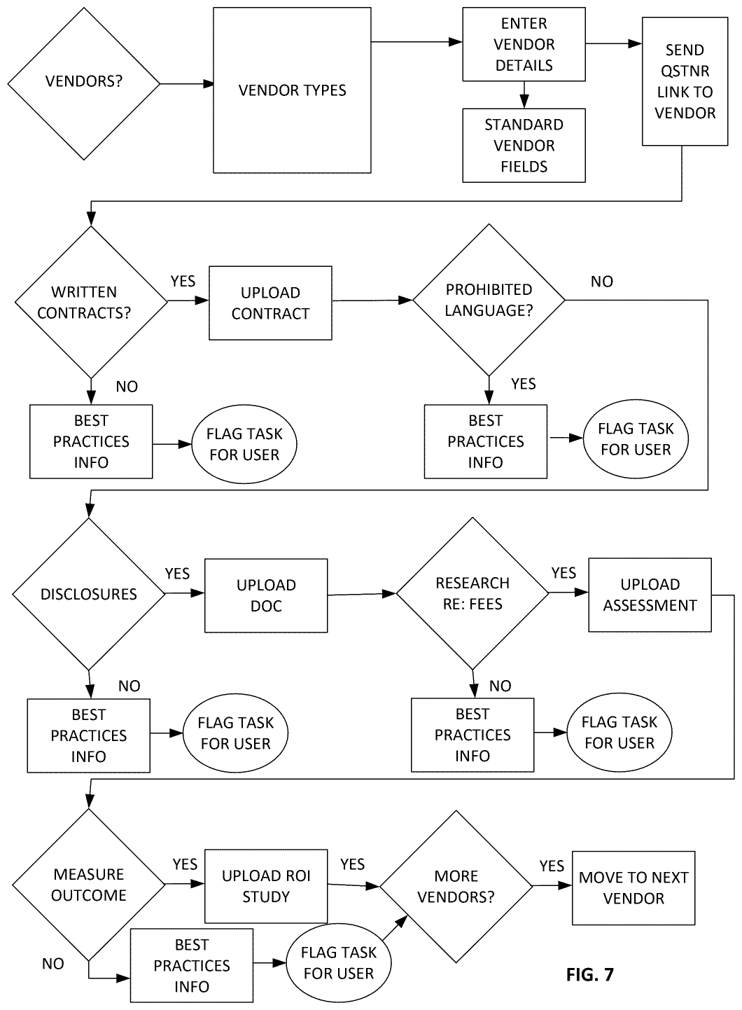

FIG. 7 illustrates another exemplary data flow operation, in this embodiment relating to vendor details. As noted in the flow diagram, this includes numerous operations or tasks subject to being flagged.

The process begins with Identify vendors associated with the plan. The user can select from a list of various vendor types. This is a multi-select, meaning you can choose more than one. Exemplary options of vendors include: Broker; Stop Loss; HSA/HRA; Concierge; TPA (Third Party Administrator); Reference Provider; Analytics; Education; PBM (Pharmacy Benefit Manager); Claims Auditor; and/or Payor/Other.

The process includes verifying details by gathering details about each vendor. Enter vendor details: Company Name; Contact Name Insurance Link. The process includes uploading vendor contract (ASC, TPA, etc.). Based on vendor details, one embodiment includes sending a questionnaire or a link to a questionnaire for completion by the vendor.

If YES: Upload document. If NO: Provide information about best practices and Flag task for user.

Another inquiry is if any amendments applied? If YES: Upload amendment. If NO: Provide information about best practices and flag task for user.

In essence, this flowchart guides the user through the process of gathering and documenting information about vendors associated with a plan. It involves: Selecting the types of vendors involved; Entering specific details for each vendor; Uploading contracts, amendments, discount information, and rate sheets; Providing best practice information if documents are not uploaded; and Iterating through multiple vendors. The process ensures that all relevant vendor information is collected and organized for the plan.

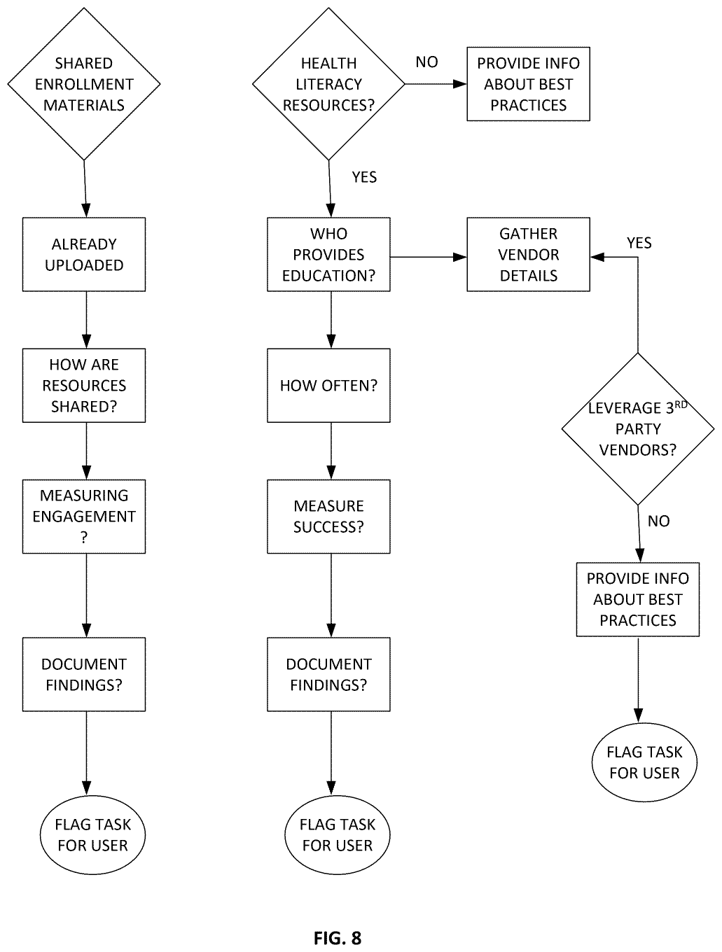

FIG. 8 illustrates an exemplary data flow operation for education and communication. For example, third party education systems can provide training to various parties. Non-limited examples of training can include, for example, fiduciary training for committee members; health insurance education for participants; pricing transparency and comparison shopping training for participants. Via communication with the third party system, the present method and system received reports, automated and/or in response to data call routines, indicating an education status or demonstrating completion of required training, completing one or more electric training segments or courses, as well as providing for data relating to the impact of those trainings.

The flowchart begins with the instruction “Add info on ‘duty to inform’”. This highlights the importance of fulfilling the legal and ethical obligation to inform participants. An inquiry is what enrollment material is being shared with participants? This question focuses on the content of the communication.

Another inquiry is how are these materials being shared, including delivery method. Another inquiry is: are you providing Health & Welfare education? If YES: Who is providing education; How often is education; Measure success; Document findings; and Flag task for user. If NO: the system can provide best practices.

Another inquiry is if the user leverages vendors or third party vendors to engage/educate participants? In essence, this flowchart guides the user through analyzing and documenting the processes for educating and communicating with participants, both internally and externally. It covers:

The flowchart emphasizes the importance of fulfilling the “duty to inform” and ensuring that participants receive clear and effective communication about their benefits.

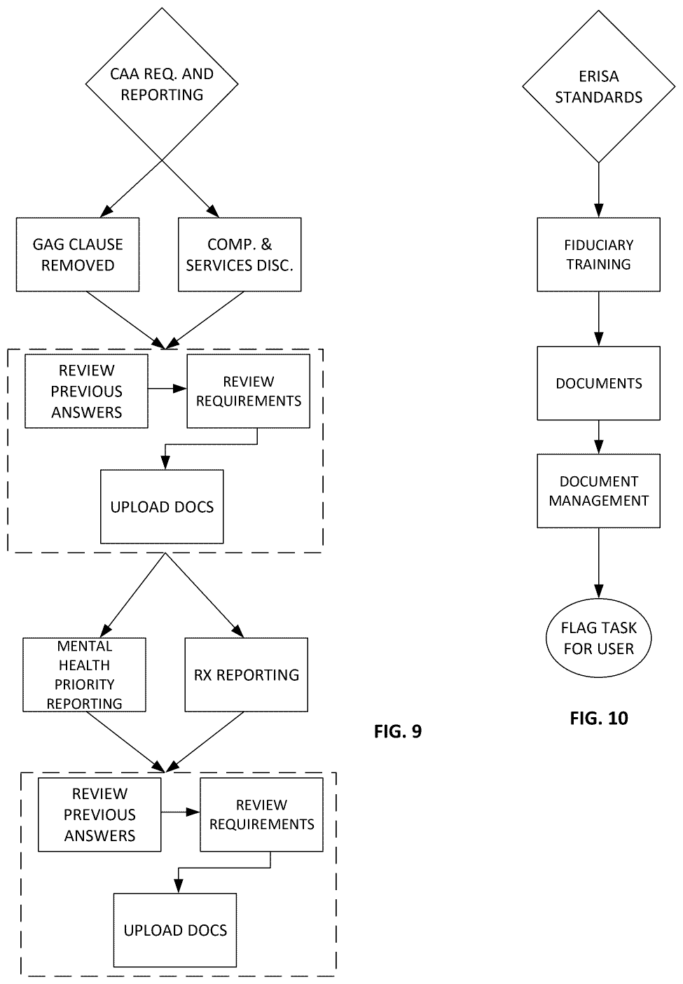

FIGS. 9-10 illustrates an exemplary embodiment of plan compliance and procedural due process. Similarly, the process includes flagging of various tasks. Moreover, as noted by star-indicators, the processing method and system provides for additional interactions with third parties, including in these exemplary embodiments providing referral(s) to third-party service providers, and/or additional information via a processing knowledge center.

During user interactions, the user interface includes a variety of questions to the user, many of those questions posed to the user represent a “best practice” being addressed. But completion of one task may have a greater impact on liability/completion of the fiduciary process than the completion of another task. Effectively, each question/task is weighted differently, and some answers will trigger follow-up questions and tasks, shifting the calculation of overall completeness as the user progresses through the system.

Therefore, one embodiment of the invention includes weighting the value of answers to each question, and scaling the various recommended tasks based on answers to other questions and tasks, completed and incomplete. By offsetting the value of a task, the system can therein generate a percentage or degree of the user completing the fiduciary process. By the same token, completeness of the fiduciary process can also relate to risk and liabilities, usable for internal knowledge and also usable for external benefits such as liability insurance or legal liability (ies) for the plan, the company, and/or executives.

Here, for example, an incomplete task of a questionable phrase in a plan document would have a lighter scaling factor than failure to complete an essential task, for example forming a management committee. The method and system therein not only manages the user interactions for data relating to a plan, but also include back-end processing for determining a weighting or scaling relating to various tasks, completed and/or incomplete.

When a user answers a question indicating that they have not yet completed a best practice, the system responds by providing information about the specific issue. This information can take the form of a short paragraph or a link to a larger article that explains the best practice in greater detail. The information provided by the system may also include the potential impact that adherence to the best practice will have on the user's liability. In addition to providing information, the system also generates recommended next steps that users can take to address the issue. These next steps are added to the user's to-do list automatically, which helps users keep track of the tasks they need to complete. The system also sets reminders for completion of these tasks, which helps users stay on track and ensure that they are taking the necessary steps to adhere to best practices.

In a further embodiment, as the method and system tracks user interaction relative to checklist(s) and other requirements, the system includes knowledge for improved user assistant. Therefore, one embodiment may include a help button or other user interface element allowing for improved interaction with the user. For example, if the user is asked to upload a document and the user unsure about the actual document, a help or assistance button can include providing further interaction with the user for both education and improved compliance. The system includes knowledge of the existing data input and therefore using this knowledge can generate a more appropriate and tailored response or instruction to the user.

As noted in FIG. 2 above, the method and system can integrate with one or more enterprise systems. For example, one embodiment includes the method and system integrated with a third-party education or training system. As part of the integration, the method and system can then dynamically track compliance-related activities using the enterprise system.

In one embodiment, the method and system having knowledge of compliance-related activities can generate an outside fiduciary audit report. While the risk assessment score provides the user with an indicator of compliance activities, the audit report can be a stand-alone document generated for a third party. This document can be used, for example, to document corporate compliance with the fiduciary requirements and providable to an auditor or other entity. This audit can also be used to further improve the user's own risk assessment score by indicating missing or incomplete plan details.

The included figures are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for generating a risk assessment associated with fiduciary compliance requirements for a user, where the user represents a business entity having a plurality of employees and operating an employee benefit program for the plurality of employees, the method comprising:
generating a user interface screen based on execution of executable software code by at least one processing device, the first user interface screen viewable by the user;
transmitting the executable software code to a user processing device and generating an output display to the user, including displaying a plurality of questions to user where the questions include questions associated with the employee benefit program;
receiving user input via the user interface screen, the user input including both user input in response to at least one of the questions and access to information having benefits data stored therein, the benefits data associated with the employee benefit program;
electronically accessing, via a networked connection, the information having the benefits data stored therein and reviewing at least a portion of the benefits data stored therein;
electronically processing both the user input in response to the at least one of the questions and the review of the at least a portion of the benefits data, wherein the processing includes comparing the user input and the benefit data to a plurality of fiduciary rules;
generating a risk assessment score the electronic processing, where the risk assessment score indicates a compliance of fiduciary requirements associated with the employee benefit program; and
based on the risk assessment and the electronic processing, generating an electronic output of instructions for the user to modify the risk assessment score.

2. The computerized method of claim 1 wherein the user is prompted via the user interface to upload a plurality of documents relating to the employee benefits program and software instructions providing electronically storing an electronic version of the plurality of documents in a document repository such that electronically accessing the access information includes accessing the document repository.

3. The computerized method of claim 2 further comprising:
executing content recognition executable software; and
reviewing the electronic version of the plurality of documents using the content recognition executable software including reviewing the written content within the plurality of documents.

4. The computerized method of claim 3 wherein the electronic version of the plurality of documents includes at least contract associated with the employee benefit program.

5. The computerized method of claim 3 further comprising:
generating at least one task for the user based on the review of the electronic version of the plurality of documents.

6. The computerized method of claim 3 further comprising:
upon reviewing the electronic version of the plurality of documents, electronically generating document tags based thereon and assigning the document tags within the document repository.

7. The computerized method of claim 6 further comprising:
analyzing the document tags; and
generating a plurality of time-based reminders for the user based thereon.

8. The computerized method of claim 3 further comprising:
for at least one of the electronic version of the plurality of documents, comparing the electronic version to a document template; and
generating a notification to the user based on the comparison, wherein the notification includes at least one statement of variance between the electronic version and the document template.

9. The computerized method of claim 1 further comprising:
as part of the user interface and the display of the plurality of questions, generating an input option for the user to seek computerized assistance with at least one of the plurality of questions; and
in response to receipt of a computerized assistance request, generating a computerized response for the user including recommendations associated with modifying the risk assessment score.

10. The computerized method of claim 1, wherein the benefits data is via a third-party database having the information stored therein, the user interface further including:
generating at least one inquiry to the user requesting account information associated with the third-party database; and
accessing the third-party database using the account information via the networked connection.

11. The computerized method of claim 10, wherein the third-party database is associated with a third-party service provider associated with providing the employee benefit program, the third-party service provider including at least one of: a benefit plan administrator, a fiduciary training provider, a document repository.

12. The computerized method of claim 1 further comprising:
accessing a best practices database having a plurality of data points relating to best practices associated with management of the employee benefits program; and
selecting at least one of the instructions for the user to modify the risk assessment score based on accessing the best practices database.

13. The computerized method of claim 1 further comprising:
tracking user input in response to the questions and tracking analysis of the third-party database; and
generating a status indicator as part of the user interface, the status indicator relating to modifying the risk assessment score.

14. The computerized method of claim 13 further comprising:
transmitting at least one inquiry to a third-party service provider in addition to processing the user input, the at least one inquiry including inquiries regarding the employee benefits program as supported by the third-party service provider;
receiving a third-party input in response to the at least one inquiry; and
modifying the risk assessment score based on the third-party input.

15. A computerized method for generating a risk assessment associated with fiduciary compliance requirements for a user, where the user represents a business entity having a plurality of employees and operating an employee benefit program for the plurality of employees, the method comprising:
generating a user interface screen based on execution of executable software code by at least one processing device, the first user interface screen viewable by the user;
transmitting the executable software code to a user processing device and generating an output display to the user, including displaying a plurality of questions to user where the questions include questions associated with the employee benefit program;
receiving user input via the user interface screen, the user input including both user input in response to at least one of the questions and access to information having benefits data stored therein, the benefits data associated with the employee benefit program, wherein the user is prompted via the user interface to upload a plurality of documents relating to the employee benefits program and software instructions providing electronically storing an electronic version of the plurality of documents in a document repository;
electronically accessing, via a networked connection, the information having the benefits data stored therein and reviewing at least a portion of the benefits data stored therein, including executing content recognition executable software; and reviewing the electronic version of the plurality of documents using the content recognition executable software including reviewing the written content within the plurality of documents;
electronically processing both the user input in response to the at least one of the questions and the review of the at least a portion of the benefits data, wherein the processing includes comparing the user input and the benefit data to a plurality of fiduciary rules;
generating a risk assessment score the electronic processing, where the risk assessment score indicates a compliance of fiduciary requirements associated with the employee benefit program; and
based on the risk assessment and the electronic processing, generating an electronic output of instructions for the user to modify the risk assessment score.

16. The method of claim 15, wherein the benefits data is via a third-party database having the information stored therein, the user interface further including:
generating at least one inquiry to the user requesting account information associated with the third-party database; and
accessing the third-party database using the account information via the networked connection.

17. The computerized method of claim 15 further comprising:
tracking user input in response to the questions and tracking analysis of the third-party database; and
generating a status indicator as part of the user interface, the status indicator relating to modifying the risk assessment score.

18. The computerized method of claim 15 further comprising:
transmitting at least one inquiry to a third-party service provider in addition to processing the user input, the at least one inquiry including inquiries regarding the employee benefits program as supported by the third-party service provider;
receiving a third-party input in response to the at least one inquiry; and
modifying the risk assessment score based on the third-party input.

19. A computerized method for generating a risk assessment associated with fiduciary compliance requirements for a user, where the user represents a business entity having a plurality of employees and operating an employee benefit program for the plurality of employees, the method comprising:
generating a user interface screen based on execution of executable software code by at least one processing device, the first user interface screen viewable by the user;
transmitting the executable software code to a user processing device and generating an output display to the user, including displaying a plurality of questions to user where the questions include questions associated with the employee benefit program;
receiving user input via the user interface screen, the user input including both user input in response to at least one of the questions and access to information having benefits data stored therein, the benefits data associated with the employee benefit program;
electronically accessing, via a networked connection, the information having the benefits data stored therein and reviewing at least a portion of the benefits data stored therein, wherein the benefits data is via a third-party database having the information stored therein, the user interface further including:
generating at least one inquiry to the user requesting account information associated with the third-party database; and
accessing the third-party database using the account information via the networked connection;
electronically processing both the user input in response to the at least one of the questions and the review of the at least a portion of the benefits data, wherein the processing includes comparing the user input and the benefit data to a plurality of fiduciary rules;
generating a risk assessment score the electronic processing, where the risk assessment score indicates a compliance of fiduciary requirements associated with the employee benefit program;
tracking user input in response to the questions and tracking analysis of the third-party database;
generating a status indicator as part of the user interface, the status indicator relating to modifying the risk assessment score;
based on the risk assessment, the status indicator, and the electronic processing, generating an electronic output of instructions for the user to modify the risk assessment score.

20. The computerized method of claim 19 further comprising:
transmitting at least one inquiry to a third-party service provider in addition to processing the user input, the at least one inquiry including inquiries regarding the employee benefits program as supported by the third-party service provider;
receiving a third-party input in response to the at least one inquiry;
accessing a best practices database having a plurality of data points relating to best practices associated with management of the employee benefits program; and
selecting at least one of the instructions for the user to modify the risk assessment score based on accessing the best practices database.
